(19) United States
(12) Patent Application Publication
(10) Pub. No.: US 2008/0317009 A1
(43) Pub. Date: Dec. 25, 2008

(54) Arrangement For Implementing Voice Transmission

(75) Inventors: Jouni Kemppainen, Tampere (FI); Lassi Korjonen, Turku (FI); Janne Pollanen, Lieto (FI); Sami Sirkia, Mynamaki (FI)

Correspondence Address: BARNES & THORNBURG LLP, 750-17TH STREET NW, SUITE 900, WASHINGTON, DC, 20006-4675, US

(73) Assignee: CVON Innovations Limited, London (GB)

(21) Appl. No.: 11/994,141

(22) PCT Filed: Jun. 30, 2006
(86) PCT No.: PCT/FI2006/050303

§ 371 Date: Jun. 12, 2008

(30) Foreign Application Priority Data
Jul. 1, 2005 (FI) 20055379

(51) Int. Cl. H04L 12/66

(52) U.S. Cl. 370/353

(57) ABSTRACT

The invention relates to an arrangement for implementing voice transmission using a subscriber line of a public switched telephone network in a system having a concentrator network part connected to the subscriber line for connecting a plurality of subscriber lines to a data transmission network. The concentrator network part includes voice traffic processing equipment, which are arranged to perform a conversion between analog voice signals of the subscriber lines and IP voice packets. It further includes transceiver and multiplexing equipment for transmitting and receiving data transferred over analog subscriber lines, and packet traffic switching equipment, which are arranged to receive and transmit packets between the voice traffic processing equipment and a core network and between the transceiver and multiplexing equipment and a core network.

### FIELD OF THE INVENTION

The invention relates to arranging voice transmission and particularly to implementing voice transmission in a network part connected to subscriber lines of a public switched telephone network.

### BACKGROUND OF THE INVENTION

During the past few years, IP voice transmission (VoIP; Voice over Internet Protocol) has become increasingly popular along with broadband Internet access, in particular. An IP call refers to voice data transmission over an IP-based network between two or more terminals. An IP call is based on transmission of packets containing voice information over an IP network. An IP network is any fixed or wireless network employing an IP protocol, such as the Internet, intranet or a local area network.

VoIP systems comprise a signalling protocol and a voice transmission protocol. The most common signalling protocols are H.323 defined by the ITU-T and SIP (Session Initiation Protocol) defined by the IETF. The end point of a VoIP protocol layer may be a VoIP gateway or an IP phone, and a gatekeeper in H.323 networks and a proxy in SIP networks may function as the control device.

IP calls are classified according to their source and destination: from a (public switched telephone network) phone to a phone; from a personal computer PC to a PC, i.e. a point-to-point VoIP call; from a PC to a phone; and from a phone to a PC. The phone-to-phone connection functions such that subscriber A makes a call by an ordinary phone to a gateway, from which the call is transmitted to an IP network and then the call is switched from the IP network to the public switched telephone network where subscriber B is. This is used in international calls, for example. The PC-to-PC connection is a totally IP-based connection, and calls are transmitted over an IP network from one computer to another, for example in a dedicated computer network of a company.

FIG. 1 illustrates a conventional arrangement for implementing voice transmission. A VoIP call provided for home subscribers typically requires the caller to have a DSL modem 104 connected to a home computer 106, VoIP software installed in the computer 106 and a microphone/headset. In the uplink, DSL data is transmitted from the DSL modem 104 to a distribution frame rack 108 and further through a band division filter 110 to a DSL concentrator DSLAM (Digital Subscriber Line Access Multiplexer) 116, which terminates DSL data transmission. The DSLAM 116 is connected to a core network 118 and further to an edge router connected to the Internet network.

To enable simultaneous use of a subscriber line for analog voice transmission and DSL data transmission, the band has to be divided by a splitter 102. In respect of calls terminating to or originating from a phone 100 in a public switched telephone network, the phone 100 is connected through a band division filter 110 of a distribution frame rack 108 located in the cross-connection site to a local phone concentrator 112. The local phone concentrator 112 connects a voice signal to a switching centre of a PSTN network 114 (not shown). From the switching centre, the call may be arranged as a VoIP call instead of an ordinary PSTN network call. In that case, the switching centre is connected to an IP gateway, which connects the PSTN network and the IP network, functions as the edge node of the IP network and performs voice conversion between the PSTN network and the IP network. VoIP call information is transmitted in both directions over the IP network, i.e. from the IP gateway to an IP server or VoIP repeater and vice versa. The VoIP server may further transmit VoIP information in both directions, for example, to another IP gateway or a VoIP terminal, which may also be called an IP phone. The IP gateway functionality is typically implemented in connection with the switching centre of a PSTN network. For example, the TIPHON project (Telecommunications and Internet Protocol Harmonization Over Networks) under the ETSI (European Telecommunications Standards Institute) has defined gateway implementations for use between a PSTN network and an IP network.

EP 1357730 describes an interface device located in the subscriber's premises for transmitting voice and data from a DSL data stream received in an ATM format from a DSL concentrator DSLAM to subscriber interface gates. If the DSL data stream includes voice, the voice data are converted into a digital voice signal and transmitted to a gate defined for an analog voice signal. The interface device functions in a corresponding manner in the case of an uplink voice signal. This arrangement, however, requires installation of a specific device in the subscriber's premises, which causes extra costs to the subscriber.

US 2004/0042510 describes implementation of DSL service in a conversion apparatus, which performs a conversion between the DSL service offered to a subscriber and the DSL service of the data network. The conversion apparatus may also digitize a POTS service into a PCM format, and the digitized information may be multiplexed with DSL data.

### BRIEF DESCRIPTION OF THE INVENTION

A new and improved arrangement has now been devised for voice transmission. The object of the invention is achieved by an arrangement, a method, a network element and a computer program product which are characterized by what is stated in the independent claims. Preferred embodiments of the invention are described in the dependent claims.

The invention is based on a new concentrator network part that supports the transmission of both data and voice information and is capable of transmitting voice information between an analog subscriber line and a network supporting a packet format voice transmission protocol, such as a network supporting the VoIP protocol. Concentrator network part of this kind comprises voice traffic processing means arranged to perform a conversion between analog voice signals of subscriber lines and IP voice packets (VoIP, Voice over IP), transceiver and multiplexing means for transmitting and receiving data transferred over analog subscriber lines, and packet traffic switching means, which are connected to the voice traffic processing means and transceiver and multiplexing means. The packet traffic switching means are arranged to receive and transmit IP packets, and the voice traffic processing means further comprise means for arranging IP call signalling in an IP network. In this context, the concentrator network part generally refers to any device or combination of devices capable of connecting a plurality of subscriber lines to another telecommunications network. The concentrator network part may be applied in a local cross-connection site, for example.

According to an embodiment of the invention, the transceiver and multiplexing means are represented by a DSL multiplexing device.

An advantage of the arrangement according to the invention is that local cross-connection sites or other premises with concentrators no longer require an interface to the operator's switching centre, but also the low-band voice signal of an analog subscriber line can be converted into a packet format already in a local concentrator and transmitted to a packet-switched network as VoIP packets. Furthermore, as the solutions according to the invention become more common, the amount of transmission resources required for circuit-switched calls in a network decreases. These advantages enable offering of ordinary calls at lower prices. From the subscriber's point of view, it is advantageous that the benefits of packet-switched voice transmission are applicable to a larger portion of the transmission path while the subscriber may utilize ordinary calls and needs no computer, application suitable for IP voice transmission, DSL modem, etc. In that case, at least some of the cost savings provided by VoIP transmission are available to users who do not want to acquire these devices. The number of voice service providers and the amount of competition may increase as different service providers may, thanks to lower initial costs, start offering analog voice services. The configuration of VoIP applications, which is often difficult for users, can also be avoided. If the subscriber only needs voice transmission, local DSL modems are no longer necessary. A further advantage compared to earlier VoIP services offered to subscribers is that voice transmission does not decrease the capacity of the DSL band.

### BRIEF DESCRIPTION OF THE FIGURES

Preferred embodiments of the invention will be described in greater detail in the accompanying drawings, in which

FIG. 1 schematically illustrates a network arrangement for providing voice transmission through an analog subscriber connection;

FIG. 2 schematically illustrates an arrangement according to an embodiment of the invention;

FIG. 3 illustrates a DSL concentrator according to an embodiment;

FIGS. 4a to 4c illustrate frequency components of signals transferred over different interfaces of FIG. 3;

FIG. 5 illustrates voice traffic processing means according to an embodiment in greater detail;

FIG. 6 illustrates division of traffic between interface C and interface G according to an embodiment;

FIG. 7 illustrates division of traffic between interface C and interface G according to another embodiment of the invention;

FIG. 8 illustrates a protocol stack related to data transmission according to an embodiment.

For the sake of clarity, the figures illustrate the present embodiments in a simplified manner.

### DETAILED DESCRIPTION OF EMBODIMENTS OF THE INVENTION

In the following, an embodiment according to the invention will be described with reference to additional functions to be implemented in a DSL concentrator. The invention is not, however, in any way limited to DSL technology but any present and future techniques usable in an analogue subscriber line may be applied. The DSL concentrator DSLAM described in the following can be replaced by a DLC device (Digital Loop Carrier), for example, or by another device connectable to an analog subscriber line. It should also be noted that, in the following, all the functions the DSL concentrator network element comprises are not necessarily performed by one device but they may be decentralized to several devices, even outside the local concentrator.

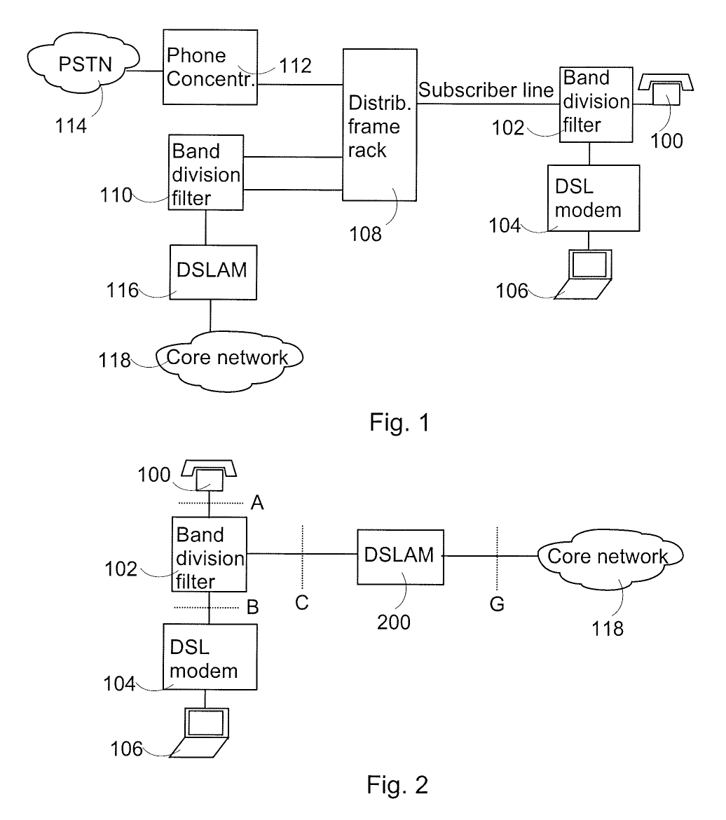

FIG. 2 illustrates an arrangement according to an embodiment for transmitting voice and data utilising an analog subscriber line. An analog phone 100 is connected to a band division filter 102 via interface A. Correspondingly, a DSL modem 104 connected to a computer 106 is connected from the band division filter 102 via interface D. The subscriber line is connected via interface C to the network element or network part 200 to function as a DSL concentrator, i.e. as a DSLAM element modified according to the present embodiment. Thus, referring to FIG. 1, the local cross-connection site or another network part comprising a DSL concentrator (116) needs not be provided with a phone concentrator 112 or a separate band division filter 110 before the DSL concentrator 116. FIG. 2 illustrates the connecting of only one subscriber but it is clear that several subscriber lines may be connected to the DSL concentrator 200.

Any DSL protocol suitable for transmitting data over an analog subscriber line may be employed between the DSL modem 104 and the DSL concentrator 200. Examples include ADSL (asymmetric digital subscriber line), HDSL (high bit rate digital subscriber line), RDSL, SDSL (symmetric digital subscriber line) and VDSL (very high bit rate digital subscriber line). It should be noted that there may also be other elements between the subscriber equipment and the DSL concentrator 200, such as a house cross-connection site. In addition to data transmission, the DSL concentrator 200 according to the present embodiment takes care of voice transmission from a packet-switched network (core network 118 in the example of FIG. 2) to an analog subscriber line and vice versa, i.e. between interface C and interface G.

The DSL concentrator 200 is connected to the operator's packet-switched core network 118 via interface G, possibly by means of a separate switch. Telecommunications protocols known per se may be applied at interface G. Examples include ATM and an Ethernet/IP-based network, but the invention is not limited to any specific core network 118 type. According to an embodiment, the DSL concentrator 200 is connected over interface G to an edge router of an Internet service provider (ISP), through which traffic is transmitted to the Internet.

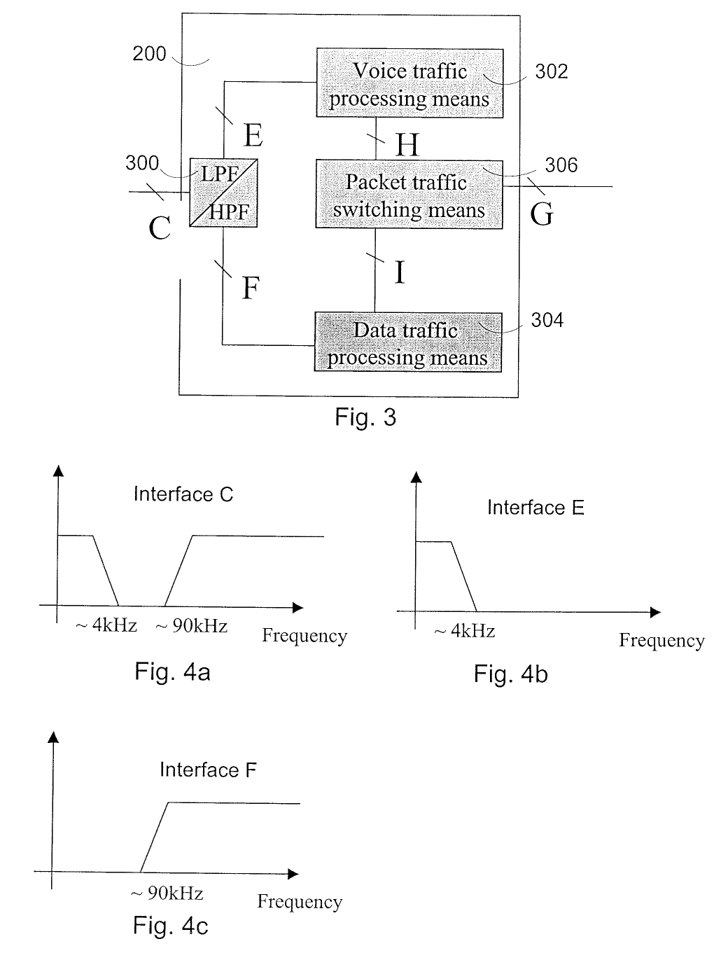

FIG. 3 illustrates a DSL concentrator network part, i.e. a DSL concentrator 200, according to an embodiment in greater detail. The DSL concentrator 200 comprises a band division filter 300, voice traffic processing means (or portion/block) 302, data traffic processing means (or portion/block) 304 and packet traffic switching means (or portion/block) 306. As can be seen from FIGS. 4a to 4c, the band division filter 300 divides frequency components of interface C that contain voice and data so that an analog voice signal is transmitted to interface E and a data signal to interface F.

The voice traffic processing means 302 are responsible, in particular, for performing a conversion between analog voice signals and voice data in a packet format. The voice traffic processing means 302 thus function as an end point of an analog subscriber connection and, on the other hand, as an end point of a packet-switched voice transmission context or a logical connection towards the core network 118 and another end point. In addition to conversion of voice information, the main tasks of the voice traffic processing means 302 include arranging signalling, such as responding to incoming signalling messages received from interface G. It also transmits the voice information packets it has generated to the packet traffic switching means 306 as well as receives packets therefrom, such as VoIP packets. In respect of a downlink incoming call, the voice traffic processing means 302 also perform signalling required by the analog subscriber line, such as call alert and call waiting signalling.

Referring to FIGS. 3 and 4b, interface E is a voice (phone) traffic interface and may be digital or analog, depending on the type of the band division filter 300 connected to the subscriber line. Interface E is used for transmitting a signal of the voice frequency band to the voice traffic processing means 302. This interface may also be connected to another processor or processing unit, in which case traffic is transmitted over this interface utilizing a communications protocol (e.g. ATM or IP). Voice information in the form of digital packets is transmitted between the voice traffic processing means 302 and the packet traffic switching means 306 over interface H. A communications protocol may also be utilized at this interface.

Referring to FIGS. 3 and 4c, interface F is an interface that transmits a signal of the frequency band of data traffic. It may also be digital or analog, depending on the type of the band division filter 300. The main tasks of the data traffic processing means 304 include receiving data traffic in the DSL transmission format from the subscriber line, transmitting the data further to the packet traffic processing means 306 (in accordance with interface I of the means 304 and 306), providing the data traffic directed to the subscriber line with the DSL transmission format and transmitting it to the subscriber line via the band division filter 300. If the filter 300 is digital, the signal is naturally transmitted over interfaces E and F in a digital format. The data traffic processing means 306 may comprise a DSL modem known per se or an access interface card, which needs not be discussed in greater detail here.

At interface I, data traffic is transmitted in a digital format between the packet traffic switching means 306 and the data traffic processing means 304. The packet traffic switching means 306 receive traffic from interface G and terminate the necessary protocol levels (e.g. ATM). They also separate voice traffic packets from the packets to the voice traffic processing means 302 and data traffic packets from interface G to interface I, i.e. to the data traffic processing means 304. In uplink, the packet traffic switching means 306 receive voice packets from interface H and data packets from interface I, add the necessary header fields and transmit the packets further to interface G. The packet traffic switching means 306 also take care of traffic multiplexing. The division of information in the speech traffic processing means 302 and in the data traffic processing part 304 may be arranged in various ways.

According to an embodiment, the means 302 and 304 have different IP addresses, in which case the packet traffic switching means 306 transmit the packets to the correct part on the basis of the IP destination addresses of the received packets. The packet traffic switching means 306 may also comprise a routing table which associates IP destination addresses with identifiers of means 302, 304 or other kind of association information for transmitting data and voice packets to the correct means on the basis of the IP destination address of the received IP packet. In the uplink, data and voice packets (possibly received from the same subscriber) have different IP source addresses, which the means 302 and 304 add to the packets. It should be noted that in an embodiment, these addresses are subscriber-specific, i.e. when voice transmission to a subscriber is being arranged, the (subscriber-specific) IP source address of an IP call is associated with the voice traffic processing means 302. The device 302 may include a domain of IP addresses, from which an IP address is allocated dynamically to the subscriber's connection for an IP connection terminating to the data traffic processing means 304 or voice traffic processing means 302.

According to another embodiment, TCP gate numbers (Transmission Control Protocol) are employed, in which case the packet traffic switching means analyze the gate numbers of TCP header fields and transmit the packet to the means 302, 304 associated with the gate number defined in the header field. According to another embodiment, UDP (User Datagram Protocol) gate identifiers are used. A combination of a TCP (or UDP) identifier and an IP address is also feasible.

According to a further embodiment, packets are transmitted to the correct means 302, 304 in the packet traffic switching means 306 utilizing a VPI/VCI (Virtual Path Identifier/Virtual Channel Identifier) identifier pair when the traffic of interface G is ATM-based. At least some of the functions of the device 200 described above can be executed in the processor of the device 200, which executes a computer program code to implement these functions. On the other hand, some of the functions may be implemented by hardware, and also a combination of hardware and software solutions can be used to implement the inventive features. Functions that require a lot of processing capacity, in particular, can be implemented by hardware. According to an embodiment, the voice traffic processing means 302, packet traffic switching means 306 and data traffic processing means 304 are controlled by executing a computer program. It should be noted that the means 302, 304 and 306 are not necessarily physically and/or functionally separate, but at least some of the functions of the blocks can be implemented in a single process. Thus, the term “means” should be understood broadly to refer to any means for implementing the defined functions. For example, the computer program code portion that controls switching of packets to the voice processing means and data processing means may form packet traffic switching means. It should also be noted that the device 200 may comprise several other functions, such as other interfaces, whose description is not necessary for understanding the invention. According to an embodiment, the device 200 supports transmission or updating of a computer program code over a data transmission network 118.

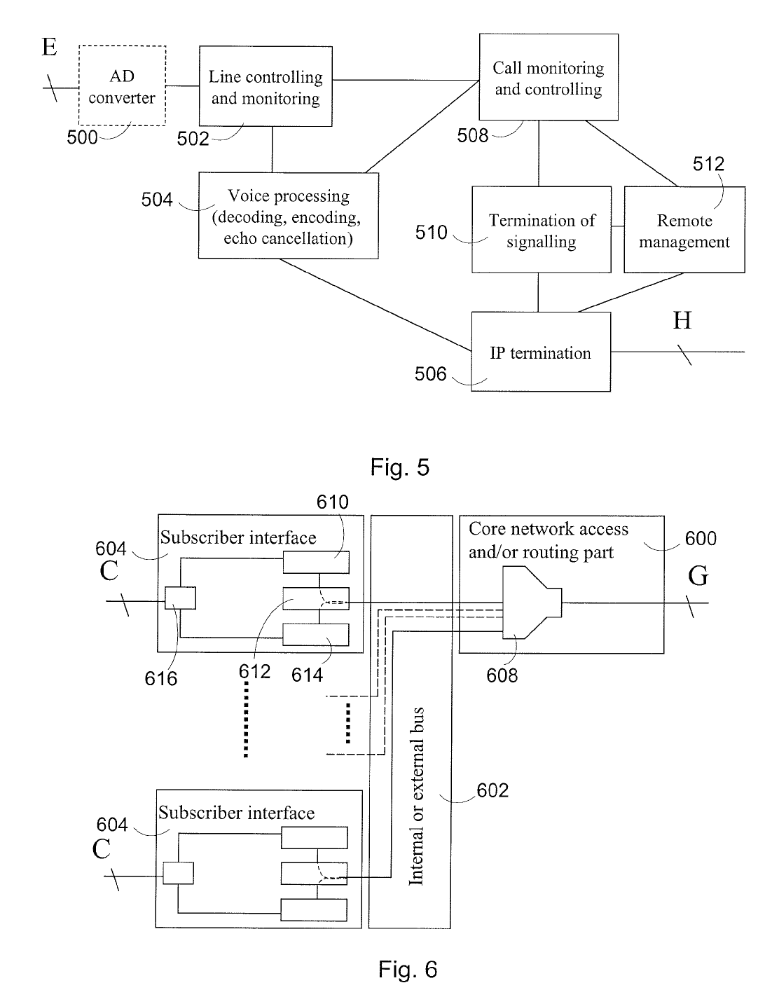

FIG. 5 illustrates different functions of the voice traffic processing means 302 according to an embodiment in greater detail. An AD converter 500 converts a signal of interface E from an analog into a digital one and vice versa. As stated above, the AD conversion may, according to an alternative embodiment, be performed separately from the voice traffic processing means 302. A control entity of interface E is denoted by reference symbol 502, and it may take care of all necessary control functions and signalling involved in a call of an analog subscriber line, including set-up of incoming and outgoing calls. Block 504 represents voice information processing functions performed on a digital signal. These include at least voice signal encoding, decoding and echo cancellation. There are various embodiments available for implementing the voice processing block 504 in the device 200. It may be implemented in various ways depending on the protocols used, and voice processing functions known per se may be implemented in block 504. Examples of codecs that may be used for IP voice packets include G.711, G.722, G.723. G.728 and G.729.

Block 508 represents an entity that controls all the functions of the voice traffic processing means 302. One of its tasks may be to control block 510 to start IP set-up in response to call set-up information received from block 502. Block 510 represents means that take care of signalling related to IP-based voice transmission and block 506 represents a block that terminates the IP connection. In other words, block 506 is responsible for establishing and unpacking IP packets, i.e. for functions of the IP protocol layer, and, according to an embodiment, also for functions of the TCP and UDP protocol layers, which are well known per se.

In the following, call set-up and termination are illustrated with reference to the example of FIG. 5. In the case of an outgoing call, the part 502 monitoring the subscriber line activates functions of the voice traffic processing means 302 when a phone on the subscriber line is hooked off. Information on this is transmitted at least to block 508, but block 504 may also be activated. Numbers are received from the subscriber line and transmitted to block 508. Block 508 controls block 510 to start IP call set-up to the destination number. In the case of an incoming call, a call entering from the network 118 is transmitted to the voice traffic processing means 302 and, more particularly, block 508 is activated. Block 508 controls the monitoring and processing block 502 of the subscriber line to generate a call alert or a call waiting tone, for example, if the subscriber is involved in an ongoing call, which is transmitted to the analog subscriber line. After the call has been answered and the required IP call signalling performed, transmission of voice information is started in both cases via blocks 504 and 506. Control block 502 detects on-hooking, and control block 508 controls block 510 to send an IP call release request. After this, the voice traffic processing means 302 return to an “idle state”.

One supplementary feature the DSL concentrator 200 may be provided with is remote management, where the owner of the DSL concentrator 200 or service provider may manage the functions of the voice traffic processing means 302 and/or other functions of the DSL concentrator 200, for example configure IP addresses, over the IP connection using a specific configuration application. Block 512 illustrates a remote management part which may be used in controlling the IP termination block 506, signalling termination block 510 and call monitoring and controlling block 508. It should be noted that all the elements shown in FIG. 5 need not be located in the DSL concentrator 200, but some of them may be located in another device. The remote management part 512 is not necessary in the DSL concentrator 200. The blocks shown in FIG. 5 illustrate different functions performed in the voice traffic processing means 302, but functions may also be performed by blocks that are functionally separate and deviate from the blocks shown in FIG. 5. At least blocks 502, 506, 508, 510 and 512 may be implemented by a program code executed in the processor of the device 200.

According to an embodiment, the voice traffic processing means 302 comprise a VoIP client application. This VoIP application may be, for example, a client application in accordance with the H.323 protocol, an SIP user agent or an application in accordance with the MGCP protocol. Some further VoIP signalling protocols applicable in the present concentrator 200 include SCCP (Skinny Client Protocol), MINET and IAX (Inter-Asterisk Exchange). A further example of VoIP technology is Skype, which is based on peer-to-peer networks.

For example, in an embodiment utilizing the SIP protocol, SIP user agent software may take care of the functions of blocks 504, 508 and 510 and the IP termination 506 may be performed by the IP protocol entity. In respect of a more detailed description of the SIP protocol, reference is made to IETF specification RFC 2543, “SIP: Session Initiation Protocol”, M. Handley et al, March 1999.

In the embodiment applying the H.323 protocol, VoIP functions are taken care of by H.323 client end point functionality in the DSL concentrator 200. The details of this functionality are known from H.323 specifications of the ITU and prior art H.323 client end point solutions. In that case, management and signalling may be implemented in blocks 508 and 510 utilizing the H.245 protocol, Q.931 protocol and/or the RAS protocol (Registration Admission and Status).

The VoIP system also comprises other elements. In the H.323 system, for example, these include a gateway, a gatekeeper providing call management services or an MCU unit (Multipoint Control Unit) for controlling conference calls, but there is no need to describe these elements more closely here.

FIG. 6 shows traffic division between interface C and interface G according to an embodiment. FIG. 6 is a functional illustration of traffic where each subscriber has a dedicated subscriber interface 604 for implementing subscriber-specific processes, i.e. processing 610 of the subscriber's voice traffic, packet traffic switching 612 and data traffic processing 614 on the traffic directed to and received from interface C of the subscriber in question. Data transfer from logical processes is switched to subscriber-specific lines of interface C via a physical filter 616. The core network 118 access and/or the routing part 600 provide an interface towards the core network and transmit data through an internal or external bus 602 to subscriber interface processes 604. The core network access and/or routing part 600 comprises a multiplexing device 608 and may take care of routing to subscriber interfaces 604 on the basis of ATM VPI/VCI identifier pairs or IP address information, for instance. It may also encapsulate and decapsulate packets in accordance with the core network protocol. The packet traffic switching process 612 may also transfer packets on the basis of their identifiers. It is clear that when a subscriber is involved only in an ongoing voice call, for example, only processes 610 and 614 are active.

FIG. 6 thus illustrates a few feasible alternatives and the elements shown therein may be located in one device (i.e. all the elements belong to the DSL concentrator 200) or decentralized when data transfer is arranged through an external bus 602 (in which case at least subscriber interfaces 604 belong to the DSL concentrator 200). It should be noted that the operation of the concentrator 200 may be arranged so that several parts of subscriber interface processes, i.e. processing of traffic of several subscribers, can be implemented in a single physical entity. Instead of the part 600, the division of the traffic of different subscribers into functionally separate processes may be carried out in the subscriber-specific packet traffic switching means 306, which may thus transmit traffic of several subscribers separated on the basis of a subscriber-specific IP address, for example, to a subscriber-specific voice traffic processing procedure 610 (or means 302) and/or to subscriber-specific data traffic processing procedure 614 (or means 304). The data traffic processing means 304, for example, may be implemented utilizing a DSL multiplexing device capable of serving several subscribers simultaneously. Naturally, the physical connections of interface C are different for each subscriber.

It should be noted that the features described above represent only some embodiments of the invention. Referring to FIGS. 2 and 5, for example, a protocol other than the IP can be used over the DSL concentrator 200 and interface G. For example, blocks 506, 508, 510, 512 may be located in connection with another network element, such as a network element of the Internet service provider, in which case the DSL concentrator 200 does not perform a conversion between analog voice packets and IP voice packets. Another protocol, such as ATM, may be used between the DSL concentrator and the device terminating the IP connection.

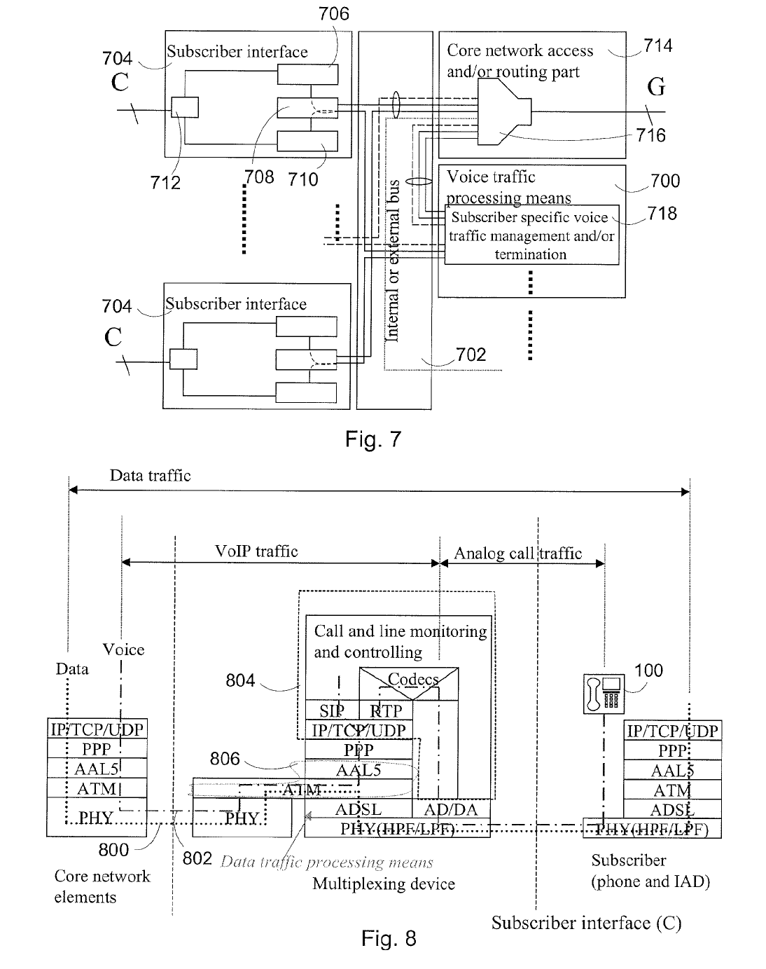

FIG. 7 illustrates an embodiment including dedicated and centralized voice traffic processing means or part 700. Subscriber interface 704 parts 708, 710 and 712 may correspond to parts 612, 614 and 616 of FIG. 6, respectively. In this embodiment, however, voice traffic has centralized voice traffic processing means 700, which are separate from subscriber interfaces and may perform several subscriber-specific voice traffic management and termination processes 718. For example, VoIP client applications may be implemented in part 700. The subscriber interfaces 704 thus comprise a second sub-portion or remote point 706 of the subscriber-specific voice traffic processing means, which are functionally connected to the correct subscriber-specific process 702. Means 706 are responsible for at least the call traffic of interface C and possibly for at least part of voice processing, too. Thus, the voice traffic processing means 302 illustrated in FIG. 3 may be implemented in a decentralized manner in means 706 and 700. Bus 702 may also be internal or external, depending on the implementation, and the core network access and/or routing part 714 may correspond to part 600 of FIG. 6 with the exception that the multiplexing device 716 guides at least a portion of the voice traffic to the voice traffic processing means 700 for centralized management and/or termination. Data traffic is transmitted directly to the subscriber's interface process 704. According to an alternative embodiment, the routing part 700 may route voice packets between different subscribers. Also in this embodiment, signalling related to transmission of voice packets may travel in a centralized manner from interface G to the voice traffic processing means 700.

FIG. 8 illustrates a protocol stack used in data transmission according to an embodiment, where data and voice are transmitted in a transmission format according to the ATM protocol between the core network 118 and the DSL multiplexing device 200.

Data transmission is illustrated by a dotted line 800. Data are transmitted in an ATM format to the multiplexing device 200, which forwards the data to an ADSL layer in the example of FIG. 8. This layer is implemented in the data traffic processing means 304 in accordance with FIG. 3. The data in the ATM format are modified for transmission in an ADSL-specific transmission format by the ADSL layer and then transmitted to the subscriber line in accordance with the ADSL transmission format. The data are filtered into an ADSL modem (104 in FIG. 2) by the apparatus in the subscriber premises, after which the ATM transmission, PPP protocol (Point-to-Point Protocol) and other higher protocols are terminated. Uplink transmission is performed in a corresponding manner in a reverse order.

Voice transmission (and signalling related to voice transmission) is illustrated by a dot-and-dash line 802. Downlink ATM header fields are removed from the data packets, i.e. the ATM protocol is terminated, in the multiplexing device 200. In the example of FIG. 8, a dense dot-and-dash line 806 illustrates protocol layers which may be implemented in the packet traffic processing means 306 of FIG. 3. In the case of data traffic 800, this means transmission of ATM packets to the ADSL layer, but in the case of voice traffic 802, the ATM protocols are terminated. The protocols and functions to be implemented in the voice traffic processing means 302 have been separated by a dotted line 804. In this embodiment, the PPP, IP and TCP/UDP protocols are terminated in the voice traffic processing means 302. In the transport protocol layer (TCP/UDP), the SIP signalling data (typically carried by a connectionoriented TCP protocol) and the actual voice data (typically carried by a connectionless UDP protocol) are separated. Furthermore, the voice traffic processing means 302 determine an SIP protocol for signalling and an RTP protocol (Real Time Protocol) for speech data. The voice data are converted using codecs and voice information is converted into an analog format suitable for a phone line. FIG. 8 also illustrates call and line control functions that control the whole voice transmission (for example, blocks 502, 510 and 512 of FIG. 5). An analog voice signal is transmitted over the subscriber line to the subscriber's premises and filtered into the phone 100. Uplink transmission is performed vice versa. It should be noted that the division between means 804 and 806 may be different; for example, the IP and TCP/UDP protocol layers may be included in the packet traffic processing means 306. In that case, the packet traffic processing means 306 transmit the payload of TCP/IP and UDP/IP packets to the other means 302, 304.

As appears from the example of FIG. 8, for instance, the method according to an embodiment comprises checking the header field of a received downlink packet, for example a VPI/VCI identifier pair, transmitting the packet to the data traffic processing means 304 in response to at least one information element of the packet header field being associated with the data traffic processing means 304, and transmitting the data included in the received packet in a DSL transmission format to the subscriber line. Alternatively, the packet is transmitted to the voice traffic processing means 302 in response to at least one information element in the packet header field being associated with the voice traffic processing means 302. The voice data included in the packet are converted for transmission to an analog line. Corresponding method steps may also be performed on uplink transmission, including conversion of voice information received from the subscriber line into a packet format and multiplexing of voice packets for transmission to the core network interface. These method steps may be implemented on the basis of a computer program code executed in the processor of the concentrator network element, for instance.

According to an embodiment, the system may prioritize calls. A prioritized call can be transmitted along a guaranteed band, which is free from interference by other traffic. In the direction of the packet-switched network 118, it is possible to utilize quality of service reservation and checking functions which are known per se and have been applied in connection with the SIP protocol, for example. On detecting that a call initiated by a subscriber is a call to be prioritized, the voice traffic processing means 302 are arranged to reserve the resources required by a high priority call for the voice packets to be transmitted. It should be noted that the quality of service reservation and checking functions may be performed on all calls. An example of quality of service reservation protocols is an RSVP (Resource Reservation Protocol) defined in RFC specification 2205 by the IETF, but the application of the present embodiment is not limited to any specific protocol.

A call directed to an emergency call number may be defined in the voice traffic processing means 302 as a call to be prioritized over data traffic and possibly over other calls. The emergency call number may be connected directly to the nearest local emergency call centre, to which a packet-switched prioritized connection can be established from the DSL concentrator 200.

According to an embodiment, the voice traffic processing means 302 are arranged to route calls, at least calls directed to the emergency call number, directly to the PSTN network. This embodiment may be applied when the DSL concentrator 200 and the voice traffic processing means 302, in particular, are connected directly or indirectly to the PSTN network 114 or to its phone concentrator 112. Routing of emergency calls from the local concentrator 200 is one advantage over VoIP calls originating from the subscriber, which may be difficult to route to the caller's nearest emergency call centre. It is obvious to a person skilled in the art that as technology advances, the inventive concept may be implemented in various ways. The invention and its embodiments are thus not restricted to the examples described above but they may vary within the scope of the claims. In some cases, the features described in this application may be used as such, regardless of the other features. On the other hand, if necessary, the features presented in this application may be combined to obtain various combinations. The drawings and the related description are only intended to illustrate the inventive concept.

1. An arrangement for implementing voice transmission using a subscriber line of a public switched telephone network in a system having a concentrator network part (200) connected to the subscriber line for connecting a plurality of subscriber lines to a data transmission network, the arrangement comprising:
voice traffic processing means (302),
transceiver and multiplexing means (304) for transmitting and receiving data transferred over analog subscriber lines; and
packet traffic switching means (306), which are connected to the voice traffic processing means and transceiver and multiplexing means and arranged to receive and transmit digital information between the voice traffic processing means and a core network and between the transceiver and multiplexing means and a core network, characterized in that the packet traffic switching means (306) are arranged to receive and transmit IP packets,
the voice traffic processing means (302) are arranged to perform a conversion between analog voice signals of subscriber lines and voice data of VoIP (Voice over IP) packets, and the arrangement comprises means (510) for arranging IP call signalling in an IP network.

2. An arrangement according to claim 1, characterized in that the voice traffic processing means (302) comprise a VoIP client application, such as an H.323 client application, an SIP user agent (Session Initiation Protocol) or a VoIP application supporting an MGCP protocol (Media Gateway Control Protocol).

3. An arrangement according to any one of the preceding claims, characterized in that the transceiver and multiplexing means (304) are represented by a DSL multiplexing device.

4. A telecommunications network element (200) for connecting a plurality of subscriber lines to a data transmission network, the telecommunications network element (200) comprising
voice traffic processing means (302),
transceiver and multiplexing means (304) for transmitting and receiving data transferred over analog subscriber lines; and
packet traffic switching means (306), which are connected to the voice traffic processing means and transceiver and multiplexing means and arranged to receive and transmit digital information between the voice traffic processing means and a core network and between the transceiver and multiplexing means and a core network, characterized in that the packet traffic switching means (306) are arranged to receive and transmit IP packets, and
the voice traffic processing means (302) are arranged to perform a conversion between analog voice signals of subscriber lines and voice data of VoIP (Voice over IP) packets, the network element comprising means (510) for arranging IP call signalling in an IP network.

5. A telecommunications network element according to claim 4, characterized in that the voice traffic processing means (302) comprise a VoIP client application, such as an H.323 client application, an SIP user agent (Session Initiation Protocol) or a VoIP application supporting an MGCP protocol (Media Gateway Control Protocol).

6. A telecommunications network element according to claim 4 or 5, characterized in that the transceiver and multiplexing means (304) are represented by a DSL multiplexing device.

7. A telecommunications network element according to any one of claims 4 to 6, characterized in that the voice traffic processing means (302) are arranged to perform controlling and monitoring of the analog subscriber line, such as signalling related to set-up and termination of calls.

8. A telecommunications network element according to any one of claims 4 to 7, characterized in that the telecommunications network element (200) is arranged to store association of the subscriber's speech traffic in a first address or identifier and association of data traffic in a second address or identifier, and
at least the packet traffic switching means (306) are arranged to transmit packets on the basis of the associations.

9. A telecommunications network element according to claim 8, characterized in that the packet traffic switching means (306) are arranged to check the destination address of an incoming packet and transmit the packet to the voice traffic processing means (302) if the packet's destination address corresponds to the first address, or to the transceiver and multiplexing means (304) if the packet's destination address corresponds to the second address, and
the voice traffic processing means (302) are arranged to add the first address to the header field of an uplink voice packet.

10. A telecommunications network element according to claim 8 or 9, characterized in that data transmission between the packet traffic switching means (306), the transceiver and multiplexing means (304) and the voice traffic processing means is IP-based, whereby the first and the second address are IP addresses.

11. A method of arranging voice transmission in a system where a concentrator network part (200) is connected to the subscriber line for connecting a plurality of subscriber lines to a data transmission network, the concentrator network part (200) comprising voice traffic processing means (302) and data traffic processing means (304), characterized in that the voice traffic processing means (302) of the concentrator network part (200) comprise means (510) for arranging signalling of an IP call to an IP network and the following steps are performed in the concentrator network part (200):
checking the header field of a received downlink IP packet,
transmitting the IP packet to the data traffic processing means (304) in response to at least one information element in the packet's header field being associated with the data traffic processing means (304) and transmitting the data included in the received packet in a DSL transmission format to the subscriber line, or
transmitting the IP packet to the voice traffic processing means (302) in response to at least one information element of the packet's header field being associated with the speech traffic processing means (302) and performing a conversion on the voice data included in the IP speech packet for transmission to an analog line.

12. A computer program product for a concentrator network part (200) connectable to a subscriber line, the concentrator network element (200) comprising voice traffic processing means (302) and data traffic processing means (304), characterized in that the computer program product comprises a computer program code which controls the network element (200) comprising means (510) for arranging IP call signalling to an IP network
to check the header field of a received downlink IP packet,
to transmit the IP packet to the data traffic processing means (304) for transmitting the data included in the received packet in a DSL transmission format to the subscriber line in response to at least one information element in the packet's header field being associated with the data traffic processing means (304), or
to transmit the IP packet to the voice traffic processing means (302) for performing a conversion on the voice data included in the IP voice packet for transmission to an analog line in response to at least one information element in the packet's header field being associated with the voice traffic processing means (302).
